(19) United States
(12) Patent Application Publication
(10) Pub. No.: US 2017/0151534 A1
(43) Pub. Date: Jun. 1, 2017

(54) SUBSTRATE FOR LIQUID FILTER AND METHOD FOR PRODUCING THE SAME

(71) Applicant: TEIJIN LIMITED, Osaka-shi, Osaka (JP)

(72) Inventors: Toyomi FUKUDA, Osaka-shi (JP); Koji FURUYA, Osaka-shi (JP); Susumu HONDA, Osaka-shi (JP)

(73) Assignee: TEIJIN LIMITED, Osaka-shi, Osaka (JP)

(21) Appl. No.: 15/320,831

(22) PCT Filed: Jun. 17, 2015
(86) PCT No.: PCT/JP2015/067502

§ 371 Date: Dec. 21, 2016

(30) Foreign Application Priority Data
Jun. 25, 2014 (JP) 2014-130045

(51) Int. Cl. B01D 69/12; B01D 69/02; B01D 67/00; B32B 5/32; C08K 3/22; B29C 47/00; B29C 47/06; B29C 55/14; C08J 9/28; C08J 9/00; B01D 71/26; B32B 27/32

(52) U.S. Cl. CPC B01D 69/12; B01D 71/26; B01D 69/02; B01D 67/0027; B01D 67/0095; B32B 5/32; B32B 27/32; B29C 47/0021; B29C 47/065; B29C 47/0057; B29C 55/143; C08J 9/28; C08J 9/0066; C08K 3/22; B01D 2323/21; B01D 2325/04; B01D 2325/28; B32B 2264/102; B29K 2023/0683

(57) ABSTRACT

An embodiment of the invention provides a substrate for a liquid filter, the substrate including at least one A layer which is a microporous membrane-like layer containing a polyolefin, and at least one B layer which is a microporous membrane-like layer containing a polyolefin and a filler, the substrate having a bubble point of from 0.40 Mpa to 0.80 Mpa and a water permeation efficiency of from 1.0 mL/min·cm² to 4.0 mL/min·cm².

### TECHNICAL FIELD

The present disclosure relates to a substrate for a liquid filter and a method for producing the same.

### BACKGROUND ART

In recent years, the progress toward downsizing and performance improvement in electronic devices is advancing more and more, and particularly, digital devices and portable terminals, as represented by personal computers and smartphones, have made great progress. It is well known that, among various techniques that lead and support such progress, technical innovation in the semiconductor industry has played a great role. In the recent semiconductor industry, the development race in the region where the wire pattern dimension is below 20 nm is going on, and many companies are hurrying the construction of the most advanced production line.

A lithography process is a process of forming a pattern in the production of semiconductor parts. Along with the recent progress of finer patterns, an extremely advanced technique is being required not only in terms of the nature of the chemical liquid itself which is used in the lithography process, but also for the handling of the chemical liquid until the chemical liquid is coated on a wafer.

A chemical liquid prepared at high level is filtrated through a dense filter immediately before coating onto a wafer, to remove particles that exert significant influence on the pattern formation or yield. In the most advanced formation of a pattern of less than 20 nm, it is required to collect particles of less than about 10 nm, and thus filter manufactures are vigorously advancing the development.

In general, a liquid filter has, as a substrate, a porous membrane made of a resin such as polyethylene, polytetrafluoroethylene, nylon, or polypropylene, and is processed into a cartridge form and used. Substrates are used properly according to the intended use, from the viewpoints of the affinity with a chemical liquid, collection efficiency, processing capacity, durability, and the like. Recently, reduction of the amount of eluted substance derived from the substrate has been particularly regarded as important, and polyethylene microporous membranes are commonly used as substrates.

Examples of a representative method for producing a polyethylene microporous membrane include a phase separation method and a stretching method. A phase separation method is a technique of forming a pore by utilizing the phase separation phenomenon of a polymer solution. Examples thereof include a heat induced phase separation method in which phase separation is induced by heat, as described in Japanese Patent Application Laid-Open (JP-A) No. H2-251545, and a non-solvent induced phase separation method utilizing the solubility characteristics of a polymer with respect to a solvent. Further, it is also possible to use the two techniques of heat induced phase separation and non-solvent induced phase separation in combination or to adjust the shape and size of the pore structure by stretching to increase the variation. A stretching method is a method including, for example, stretching a polyethylene raw sheet, which has been molded into a sheet-like form, to draw the amorphous portion in the crystal structure, under adjusted stretching conditions including the speed, magnification, temperature, and the like, thereby forming micropores between lamella layers, while forming microfibrils (see, for example, JP-A No. 2010-053245, JP-A No. 2010-202828, JP-A No. H7-246322, and JP-A No. H10-263374).

### DISCLOSURE OF THE INVENTION

### Problem to be Solved by the Invention

However, when fine particles having diameter of less than about 10 nm are tried to be collected effectively, the liquid permeability tends to deteriorate. Namely, there is a trade-off relationship between collection efficiency and liquid permeability.

Further, in the long-term use of a liquid filter, due to repeated application of pressure to the polyolefin microporous membrane, the porous structure may change, and the liquid permeability may deteriorate gradually. In order to address such a problem of long-term stable use, it is thought, for example, that it is effective to provide a polyolefin microporous membrane with a rigid structure. However, a rigid polyolefin microporous membrane also exerts influence on the collection efficiency and on the liquid permeability.

In the conventional technology as described in the publications described above, a proposal has not been made, which achieves excellent collection efficiency with respect to fine particles having diameter of less than about 10 nm and excellent liquid permeability, and also realizes stable liquid permeability in long-term use.

Thus, in order to address the above problems, it is an object of the present disclosure to provide a substrate for a liquid filter, which has excellent collection efficiency with respect to fine particles having diameter of less than about 10 nm, as well as excellent liquid permeability, and also has stable liquid permeability in long-term use, and a method for producing the same.

### Means for Solving the Problem

Specific means for addressing the above problems include the following embodiments.

1. A substrate for a liquid filter, the substrate having at least one A layer which is a microporous membrane-like layer containing a polyolefin, and at least one B layer which is a microporous membrane-like layer containing a polyolefin and a filler, the substrate having a bubble point of from 0.40 MPa to 0.80 MPa and a water permeation efficiency of from 1.0 mL/min·cm² to 4.0 mL/min·cm².

2. The substrate for a liquid filter according to 1 above, wherein a content of the filler in the B layer is from 40% by mass to 80% by mass, with respect to a total mass of all solids in the B layer.

3. The substrate for a liquid filter according to 1 above or 2 above, wherein a porosity of the substrate is 50% or more and less than 75%.

4. The substrate for a liquid filter according to any one of 1 to 3 above, wherein a thickness of the substrate is from 7 μm to 25 μm.

5. The substrate for a liquid filter according to any one of 1 to 4 above, wherein the polyolefin that is contained the A layer and the B layer is formed from a polyethylene composition obtained by mixing an ultra-high molecular weight polyethylene having a weight-average molecular weight of 900,000 or more and a high-density polyethylene having a weight-average molecular weight of from 200,000 to 800,000 and a density of from 0.92 g/cm³ to 0.96 g/cm³.

6. The substrate for a liquid filter according to any one of 1 to 5 above, wherein an average particle diameter of the filler in the B layer is from 0.2 μm to 2.0 μm.

7. A method for producing the substrate for a liquid filter according to any one of 1 to 6 above,

wherein the method includes: a process of preparing a first solution (a liquid for forming the A layer) containing a polyolefin and a solvent; a process of preparing a second solution (a liquid for forming the B layer) containing a polyolefin, a solvent, and a filler; a process of co-extruding a melt-kneaded substance obtained by melting and kneading the first solution and a melt-kneaded substance obtained by melting and kneading the second solution from a die, and cooling and solidifying the same, to obtain a multilayered gel-like molded substance; a process of stretching the multilayered gel-like molded substance in at least one direction; and a process of removing at least a portion of the solvent in the multilayered gel-like molded substance, before or after the process of stretching in at least one direction.

### Effect of the Invention

According to an embodiment of the present invention, a substrate for a liquid filter, which has excellent collection efficiency with respect to fine particles having diameter of less than about 10 nm, as well as excellent liquid permeability, and also has stable liquid permeability in long-term use, and a method for producing the same may be provided.

### BEST MODE FOR CARRYING OUT THE INVENTION

Hereinafter, the embodiments of the invention are explained sequentially. These explanations and examples illustrate the embodiments of the invention, and do not limit the scope of the embodiments of the invention.

Note that, throughout this specification, a numeral range described by using the term “to” represents a numeral range including the upper limit and the lower limit.

Further, regarding a polyolefin microporous membrane, the term “longitudinal direction” means the direction of the length of the polyolefin microporous membrane produced in an elongated shape, and the term “width direction” means the direction that is perpendicular to the longitudinal direction of the polyolefin microporous membrane. Hereinafter, the “width direction” may also be referred to as “TD”, and the “longitudinal direction” may also be referred to as “MD”.

[Substrate for Liquid Filter]

The substrate for a liquid filter according to the embodiment of the invention has at least one A layer, which is a microporous membrane-like layer containing a polyolefin, and at least one B layer, which is a microporous membrane-like layer containing a polyolefin and a filler. Namely, the substrate for a liquid filter according to the embodiment of the invention is composed of a layered polyolefin microporous membrane equipped with at least one A layer and at least one B layer. The substrate for a liquid filter, which is a layered polyolefin microporous membrane, has a bubble point of from 0.40 Mpa to 0.80 Mpa and a water permeation efficiency of from 1.0 mL/min·cm² to 4.0 mL/min·cm².

According to such an embodiment of the invention, a substrate for a liquid filter, which has excellent collection efficiency with respect to fine particles having diameter of less than about 10 nm, as well as excellent liquid permeability, and also has stable liquid permeability in long-term use, may be provided.

Hereinafter, details of each constitution are explained.

(Layered Polyolefin Microporous Membrane)

In this disclosure, the layered polyolefin microporous membrane, which is the substrate for a liquid filter, is a layered polyolefin microporous membrane equipped with at least one A layer, which is a microporous membrane-like layer containing a polyolefin, and at least one B layer, which is a microporous membrane-like layer containing a polyolefin and a filler.

The layered polyolefin microporous membrane is required to have at least one A layer and at least one B layer. The number of layers that are layered one on another and the lamination order are not particularly limited.

The number of layers that are layered one on another is preferably two or three, from the manufacturing point of view.

Concerning the lamination order, for example, A layer/B layer, A layer/B layer/A layer, B layer/A layer/B layer, A layer/A layer/B layer, or A layer/B layer/B layer is preferable.

In the layered polyolefin microporous membrane according to the embodiment of the invention, a third layer other than the A layer or the B layer may be layered, within a range in which the effects of the embodiment of the invention are not impaired.

(A Layer)

In this disclosure, the A layer is a microporous membrane-like layer that contains a polyolefin.

Here, the “microporous membrane-like” form means a membrane structure, in which fibrils of polyolefin form a three-dimensional network structure, and which has a large number of micropores inside the membrane and is configured such that the micropores are connected to each other, through which gas or liquid can pass through from one side to the other side.

Examples of the polyolefin include homopolymers or copolymers of polyethylene, polypropylene, polybutylene, polymethylpentene, or the like, and mixtures of two or more kinds thereof. Among them, polyethylene is preferable.

As polyethylene, it is preferable to use a high-density polyethylene, a mixture of a high-density polyethylene and an ultra-high molecular weight polyethylene, or the like. A high-density polyethylene indicates a crystalline polyethylene in which the repeating units, ethylene, link together to form a straight chain, and is defined as a polyethylene having a density of 0.92 g/cm³ or higher, in accordance with JIS K6748 (1995).

As a polyolefin to be used in the embodiment of the invention, it is preferable to use a polyethylene composition containing 5% by mass or more of an ultra-high molecular weight polyethylene having a weight-average molecular weight of 600,000 or more, more preferably a polyethylene composition containing 7% by mass or more of an ultra-high molecular weight polyethylene, and particularly preferably a polyethylene composition containing from 13% by mass to 27% by mass of an ultra-high molecular weight polyethylene.

When appropriate amounts of two or more kinds of polyethylene are mixed, a network structure is formed, associated with fibrilization at the time of stretching, and an effect on increasing the pore generation rate is exhibited. It is preferable that the mean weight-average molecular weight after the mixing of two or more kinds of polyethylene is from 350,000 to 2,500,000. Particularly, a polyethylene composition obtained by mixing the above-described ultra-high molecular weight polyethylene having a weight-average molecular weight of 900,000 or more and a high-density polyethylene having a weight-average molecular weight of from 200,000 to 800,000 and a density of from 0.92 g/cm³ to 0.96 g/cm³ is preferable. In this case, the proportion of the high-density polyethylene in the polyethylene composition is preferably 95% by mass or lower, more preferably 93% by mass or lower, and particularly preferably from 87% by mass to 73% by mass. The proportion of the high-molecular weight polyethylene in the polyethylene composition is preferably 5% by mass or higher, more preferably 7% by mass or higher, and particularly preferably from 13% by mass to 27% by mass.

Here, the weight-average molecular weight can be obtained by dissolving by heating a polyolefin microporous membrane sample in o-dichlorobenzene, and performing measurement by using GPC (ALLIANCE GPC model 2000, manufactured by Waters Corporation, columns: GMH6-HT and GMH6-HTL), under the conditions of a column temperature of 135° C. and a velocity of flow of 1.0 mL/min.

(B Layer)

In this disclosure, the B layer is a microporous membrane-like layer that contains a polyolefin and a filler. Here, the “microporous membrane-like” form in the B layer is similar to that in the A layer; however, a filler exists in a three-dimensional network structure formed of fibrils of polyolefin, in a form in which the filler is captured in the structure.

As the polyolefin to be used in the B layer, a substance which is the same as the polyolefin used in the A layer can be used. Above all, it is preferable to form the A layer and the B layer by using the same polyolefin, from the viewpoint of improving the adhesive properties of the two layers. Particularly, it is preferable to use, as the polyolefin contained in the A layer and the B layer, a polyethylene composition obtained by mixing the ultra-high molecular weight polyethylene and high-density polyethylene described above.

As the filler to be used in the B layer, either an inorganic matter or an organic matter can be used. The filler is required to have a nature such that the filler does not dissolve in the course of the production of a layered polyolefin microporous membrane, and does not dissolve into a liquid to be treated, also in the liquid filter.

Examples of an inorganic filler include metal hydroxides such as aluminum hydroxide, magnesium hydroxide, calcium hydroxide, chromium hydroxide, zirconium hydroxide, cerium hydroxide, nickel hydroxide, or boron hydroxide; metal oxides such as alumina, zirconia, or magnesium oxide; carbonates such as calcium carbonate or magnesium carbonate; sulfates such as barium sulfate or calcium sulfate; and clay minerals such as calcium silicate or talc. Above all, it is preferable that the inorganic filler is made of at least one of a metal hydroxide or a metal oxide.

The fillers described above may be used singly or may be used in combination of two or more kinds thereof. In addition, an inorganic filler that has been surface-modified by using a silane coupling agent or the like can also be used.

Examples of an organic filler may include crosslinked polymer particles of a crosslinked polyacrylic acid, a crosslinked polyacrylic acid ester, a crosslinked polymethacrylic acid, a crosslinked polymethacrylic acid ester, a crosslinked polymethyl methacrylate, a crosslinked polysilicone (polymethylsilsesquioxane or the like), a crosslinked polystyrene, a crosslinked polydivinylbenzene, a crosslinked styrene-divinylbenzene copolymer material, polyimide, a melamine resin, a phenol resin, a benzoguanamine-formaldehyde condensate, or the like; and heat-resistant polymer particles of polysulfone, polyacrylonitrile, aramid, polyacetal, thermoplastic polyimide, or the like. Further, the organic resin (polymer) that constitutes these organic particles may be a mixture, a modified body, a derivative, a copolymer (a random copolymer, an alternating copolymer, a block copolymer, or a graft copolymer), or a crosslinked body (in the case of the heat-resistant polymers described above) of the materials exemplified above.

In this disclosure, the average particle diameter of the filler is preferably from 0.2 μm to 2.0 μm, from the viewpoint of enhancing the efficiency of collection of the gel-like particles in a case in which gel-like particles are incorporated in the liquid to be treated.

When the average particle diameter of the filler is 0.2 μm or more, a favorable porous structure is likely to be formed when forming pores by stretching and heat treatment, and the bubble point and water permeation efficiency can be further improved. From such a point of view, it is more preferable that the average particle diameter of the filler is 0.4 μm or more. Meanwhile, when the average particle diameter of the filler is 2.0 μm or less, pores are likely to be formed into an appropriate size, and the efficiency of collection of gel-like particles can be further improved. From such a point of view, it is more preferable that the average particle diameter of the filler is 1.0 μm or less.

The average particle diameter of the filler is a value which can be measured by using a laser diffraction particle size distribution analyzer, and determined as a median particle diameter (D50) in a volume particle size distribution.

In this disclosure, the content of the filler in the B layer is preferably from 40% by mass to 80% by mass, with respect to the total mass of all solids in the B layer.

When the content of the filler is 40% by mass or higher, a favorable bubble point and a favorable water permeation efficiency are likely to be obtained. From such a point of view, it is more preferable that the content of the filler is 45% by mass or higher. Meanwhile, when the content of the filler is 80% by mass or lower, the filler becomes to be favorably dispersed in a resin, and defects are less likely to be generated, and also, there is a tendency that the mechanical strength of the film is improved. From such a point of view, it is more preferable that the content of the filler is 75% by mass or lower.

—Water Permeation Efficiency (Water Flow Rate)—

The substrate for a liquid filter (layered polyolefin microporous membrane) according to the embodiment of the invention is characterized by having excellent flow rate properties.

The water permeation efficiency of the substrate for a liquid filter is from 1.0 mL/min·cm² to 4.0 mL/min·cm², under a pressure differential of 90 kPa. When the water permeation efficiency of the substrate for a liquid filter is less than 1.0 mL/min·cm², a sufficient water permeation efficiency as a liquid filter for particles having diameter of less than about 10 nm is not obtained, and thus, problems such as a decrease in the productivity of liquid filtration or an increase in the energy burden required to maintain the liquid feeding amount (productivity) may occur. From such a point of view, the water permeation efficiency is more preferably 1.5 mL/min·cm² or more. Meanwhile, when the water permeation efficiency of the substrate for a liquid filter exceeds 4.0 mL/min·cm², fine particles having diameter of less than about 10 nm cannot be sufficiently collected, a problem in that a sufficient collection efficiency is not exhibited may occur. From such a point of view, the water permeation efficiency is more preferably 3.5 mL/min·cm² or less.

The water permeation efficiency is a value which can be determined according to the following method.

A substrate for a liquid filter (layered polyolefin microporous membrane) is immersed in ethanol, then dried under room temperature, and then placed on a 37-mm diameter liquid permeation cell made of stainless steel (liquid permeation area: S cm²). The substrate for a liquid filter on the liquid permeation cell is wetted with a small amount (0.5 mL) of ethanol. Thereafter, pure water V (100 mL) which has been weighed in advance is passed therethrough at a pressure differential of 90 kPa, and the time T1 (min) needed for the entire amount of pure water to pass is measured. The measurement is carried out under an atmosphere of 24° C. Using the obtained values, the water permeation efficiency is calculated according to the following equation.

Water permeation efficiency (Vs)=V/(T1×S)

—Bubble Point—

The substrate for a liquid filter (layered polyolefin microporous membrane) according to the embodiment of the invention is characterized in that particles of less than about 10 nm (more preferably, particles of several nanometers) are collected at high level.

A bubble point refers to a pressure (MPa) needed for air (bubble) to pass through a hole from one side toward the other side, when applying pressure to the substrate for a liquid filter (layered polyolefin microporous membrane) in the state of being in contact with a liquid (in this embodiment, ethanol), and is a value which can be measured in accordance with ASTM E-128-61.

The bubble point of the substrate for a liquid filter is from 0.40 MPa to 0.80 MPa. The substrate for a liquid filter (layered polyolefin microporous membrane) according to the embodiment of the invention exhibits a favorable water permeation efficiency as described above, while having a bubble point in a range of from 0.40 MPa to 0.80 MPa.

When the bubble point of the substrate for a liquid filter is lower than 0.40 MPa, fine particles as described above cannot be sufficiently collected, and a sufficient collection efficiency is not realized. From such a point of view, the bubble point is more preferably 0.45 MPa or higher. Meanwhile, when the bubble point of the substrate for a liquid filter is 0.80 MPa or higher, the water permeation efficiency is remarkably insufficient, and the case in which a stable liquid permeability cannot be realized in long-term use may occur. From such a point of view, the bubble point is more preferably 0.70 MPa or lower.

In this disclosure, it is necessary that the water permeation efficiency and bubble point described above are adjusted within appropriate ranges, respectively. Techniques for controlling these physical properties are not particularly limited. Examples thereof include a technique of adjusting the production conditions, such as the average molecular weight of the polyethylene resin used in the A layer and B layer, the content of the filler in the B layer, the mixing ratio of the polyethylene resins in the case of using a plurality of polyethylene resins by mixing, the polyethylene resin concentration in the raw material, the mixing ratio of the solvents in the case of using a plurality of solvents by mixing in the raw material, the heating temperature and the push pressure in order to squeeze a solvent contained in the extruded multilayered gel-like molded substance (sheet-like substance), the stretching magnification, the heat treatment (heat fixation) temperature in the case of performing heat treatment after stretching, or the immersion time in the extraction solvent. Specifically, as described below in the description of the production method, when the mass proportion of the ultra-high molecular weight polyethylene used in the A layer and B layer in the entire polyethylene composition is from 1% to 35% in each layer, the content of the filler in the entire composition is from 40% to 80% in terms of mass proportion, a suitable push pressure is applied while heating at a temperature of from 40° C. to 100° C. in order to squeeze a portion of the solvent contained in the extruded multilayered gel-like molded substance (sheet-like substance), the total stretching magnification (the product of the longitudinal stretching magnification and the transverse stretching magnification) is from 20 times to 60 times, the heat fixation temperature is set at a temperature of from 110° C. to 140° C. in the case of performing heat fixation, or the like, the above physical properties can be suitably obtained.

—Porosity—

In this disclosure, the porosity of the substrate for a liquid filter (layered polyolefin microporous membrane) is preferably 50% or more but less than 75%, more preferably from 50% to 75%, and still more preferably from 60% to 75%. In a case in which the porosity of the polyolefin microporous membrane is 50% or more, the water permeation efficiency is further improved, which is thus preferable. Meanwhile, in a case in which the porosity is 75% or less, the mechanical strength of the substrate for a liquid filter is improved and the handling property is also improved, which is thus preferable.

Here, the porosity (c) of a layered polyolefin microporous membrane, which is a substrate for a liquid filter, is calculated according to the following equation.

£(%)={1−Ws/(ds·t)}×100

Ws: Mass per unit area of the polyolefin microporous membrane (g/m²)

ds: True density of polyolefin (g/cm³)

t: Membrane thickness of the polyolefin microporous membrane (μm)

—Thickness—

In this disclosure, the membrane thickness of the substrate for a liquid filter (layered polyolefin microporous membrane) is preferably from 7 μm to 25 μm, and more preferably from 10 μm to 20 μm. In a case in which the membrane thickness of the substrate for a liquid filter is 7 μm or more, a sufficient mechanical strength is likely to be obtained, and the handling property at the time of processing of the polyolefin microporous membrane and the like, and durability in the long-term use of a filter cartridge are likely to be obtained, which is thus preferable. Meanwhile, in a case in which the membrane thickness of the substrate for a liquid filter is 25 μm or less, a sufficient water permeation efficiency is likely to be obtained with the single membrane, which is thus preferable. Further, in a filter cartridge having a predetermined size, a larger filtration area is likely to be obtained, and it becomes easier to design the flow rate and structure of the filter when processing the polyolefin microporous membrane to obtain a substrate for a liquid filter, which is thus preferable.

For example, in the case of assuming that a filter cartridge is to be stored in a housing having the same size, as the thickness of the filter material (all the constituent materials including the substrate for a filter) gets thinner, the area of the filter material can be made larger, and therefore, it becomes possible to achieve a high flow rate/low filtration pressure design, which is preferable as a liquid filter. That is, it is possible to design such that, as a liquid filter, in a case in which the same flow rate is expected to be maintained, the filtration pressure is decreased, and in a case in which the same filtration pressure is expected to be maintained, the flow rate is increased. In particular, when the filtration pressure is decreased, the probability, in which the particles once collected are continuously exposed to the filtration pressure inside the filter material and thus, with the lapse of time, the particles are pushed out from the inside of the filter material together with the filtrate and leak out, is remarkably decreased. Further, the probability, in which the gas that is dissolved and exists in the liquid to be filtrated appears in the form of fine bubbles due to the pressure differential between before and after filtration (decrease in pressure after filtration), is remarkably decreased. Moreover, improvement in filtration yield of the filtration object such as a chemical liquid and also the effect on maintaining the qualities at high level over a long time can be expected.

Meanwhile, as the thickness of a filter material gets thinner, the strength and durability of the filter material get lower. However, if it is possible in designing a filter, it is possible to adjust the designing of durability and flow rate by, for example, integrating the filter with a high-strength support with a coarse mesh (for example, processing to pile them up and fold the assembly, or the like) for reinforcement.

—Liquid Filter—

After appropriately performing processing to impart affinity with chemical liquids, the above-described substrate for a liquid filter according to the embodiment of the invention is processed in the form of a cartridge, and can be used as a liquid filter.

A liquid filter is an instrument for removing the particles from a liquid to be treated which contains particles made of an organic matter and/or an inorganic matter. Particles exist in the liquid to be treated in the form of a solid or a gel. The embodiment of the invention is preferable for the removal of particles having a particle diameter of less than about 10 nm (more preferably, several nanometers). The liquid filter can be used not only in the production process of a semiconductor, but also in other production processes, for example, display production, polishing, and the like.

As a substrate for a liquid filter, for example, a porous substrate formed from polytetrafluoroethylene and/or polypropylene is well known.

The above-described substrate formed of a polyolefin microporous membrane in the embodiment of the invention has favorable affinity with chemical liquids, as compared with a polytetrafluoroethylene porous substrate. Accordingly, for example, it becomes easier to perform processing to impart affinity with chemical liquids to the filter. Further, in a case in which the filter cartridge is mounted in a filter housing and a chemical liquid is introduced, an air pocket is less likely to be formed in the filter cartridge, and the yield of filtration of the chemical liquid is improved. Moreover, since a polyethylene resin itself does not contain a halogen element, it is easy to handle the used filter cartridge, which is effective in reducing the environmental burden or the like.

[Method for Producing Substrate for Liquid Filter (Layered Polyolefin Microporous Membrane)]

The substrate for a liquid filter (layered polyolefin microporous membrane) according to the embodiment of the invention has at least an A layer and a B layer, and may be produced by any method as far as the method is a method capable of obtaining the bubble point and water permeation efficiency described above. In the embodiment of the invention, the substrate for a liquid filter according to the embodiment of the invention is preferably produced by a method for producing a substrate for a liquid filter, the method including the following process (I) to process (V). Namely:

(I) concerning the A layer, a process of preparing a first solution containing a polyolefin (preferably, a polyolefin composition containing 5% by mass or more of polyolefin, and more preferably, the polyethylene composition described above), and a solvent;

(II) concerning the B layer, a process of preparing a second solution containing a polyolefin (preferably, a polyolefin composition containing 5% by mass or more of polyolefin, and more preferably, the polyethylene composition described above), a solvent, and a filler;

(III) a process of co-extruding a melt-kneaded substance obtained by melting and kneading the first solution of process (I) above and a melt-kneaded substance obtained by melting and kneading the second solution of process (II) above from a die (preferably, a flat die), and cooling and solidifying the same, to obtain a multilayered gel-like molded substance;

(IV) a process of stretching the multilayered gel-like molded substance in at least one direction; and

(V) before or after the process of stretching in at least one direction, a process of removing at least a portion of the solvent in the multilayered gel-like molded substance.

In the above, any of process (IV) or process (V) may be performed previously. However, by carrying out the following processes in order, the substrate for a liquid filter according to the embodiment of the invention can be more preferably produced.

(VI) A process of squeezing a portion of the solvent from the multilayered gel-like molded substance, before stretching the multilayered gel-like molded substance in at least one direction

(VII) A process of stretching the multilayered gel-like molded substance, in which the solvent has been squeezed, in at least one direction

(VIII) A process of extracting and washing the solvent from the inside of the intermediate molded substance that has been stretched

In process (I), a first solution (a solution for forming the A layer above) containing a polyolefin (preferably, a polyolefin composition including 5% by mass or more of polyolefin, and more preferably, the polyethylene composition described above) and a solvent (preferably, a non-volatile solvent having a boiling point at atmospheric pressure of 210° C. or higher), which are incorporated in the A layer, is prepared. Here, it is preferable that the solution is a thermally reversible sol-gel solution, that is, the polyolefin is dissolved by heating in the solvent to form a sol, thereby preparing a thermally reversible sol-gel solution.

The solvent in process (I) is not particularly limited, as far as the solvent can sufficiently swell or can dissolve the polyolefin. It is preferable to use a non-volatile solvent having a boiling point at atmospheric pressure of 210° C. or higher or a mixed solvent of the non-volatile solvent and a volatile solvent having a boiling point at atmospheric pressure of lower than 210° C. Preferable examples of the non-volatile solvent include liquid paraffin, paraffin oil, mineral oil, castor oil, and a solvent obtained by using two or more kinds thereof in combination. Among them, liquid paraffin is preferable as the non-volatile solvent. Preferable examples of the volatile solvent include tetralin, ethylene glycol, decalin, toluene, xylene, diethyl triamine, ethylenediamine, dimethyl sulfoxide, hexane, and a solvent obtained by using two or more kinds thereof in combination.

In the solution in process (I), from the viewpoint of controlling the liquid permeability of the substrate for a liquid filter (layered polyolefin microporous membrane) and the collection efficiency as a filter material, the concentration of polyolefin is preferably from 10% by mass to 45% by mass, and more preferably from 13% by mass to 25% by mass, with respect to the total mass of the solution. When the concentration of polyolefin is 10% by mass or higher, the mechanical strength can be favorably maintained, excellent handling property is achieved, and further, in the formation of a polyolefin microporous membrane, the frequency of occurrence of breakage may be suppressed low. When the concentration of polyolefin is 45% by mass or lower, pores are likely to be formed.

In process (II), a second solution (a solution for forming the B layer above) containing a polyolefin (preferably, a polyolefin composition including 5% by mass or more of polyolefin, and more preferably, the polyethylene composition described above), a solvent, and a filler, which are incorporated in the B layer, is prepared. Process (II) can be carried out simultaneously with process (I) above.

The kind of solvent used in process (II), the content of the solvent, the kind of polyolefin, and the concentration of polyolefin are the same as those in process (I) above, respectively.

The content of the filler in the second solution is preferably from 40% by mass to 80% by mass, and more preferably from 45% by mass to 75% by mass, with respect to the total mass of the polyolefin and the filler.

In process (III), the first solution and the second solution, which have been prepared in process (I) and process (II), are each separately melt-kneaded in a kneader, and the obtained melt-kneaded substances are co-extruded from a die (preferably, a flat die), and then cooled and solidified, to obtain a multilayered gel-like molded substance. Preferably, the melt-kneaded substances are co-extruded from a die (preferably, a flat die) at a temperature within a range of from the melting point of the polyolefin to the “melting point+65° C.”, to obtain an extruded substance. Subsequently, the extruded substance is cooled, to obtain a multilayered gel-like molded substance.

As a flat die, a multi-manifold type, a field block type, or a stack plate type can be used. The molded substance is preferably formed into a sheet form.

Cooling may be quenching with an aqueous solution or an organic solvent, or may be casting on a cooled metal roll. In general, for cooling, a method of quenching with water or the volatile solvent that has been used at the time of the sol-gel solution may be employed. The cooling temperature is preferably from 10° C. to 40° C.

It is preferable that a water stream is provided on the surface layer of the water bath and a multilayered gel-like molded substance is prepared. Thereby, the mixed solvent, which is released from the inside of the molded substance (for example, sheet) that has been gelled in the water bath and which floats on the surface of the water, can be prevented from adhering again to the molded substance.

Process (IV) is a process of stretching the multilayered gel-like molded substance in one direction or two directions (for example, MD and TD). Before or after the process of stretching in one direction or two directions (for example, MD and TD), process (V) may be provided. In process (V), at least a portion of the solvent in the multilayered gel-like molded substance is removed.

Further, process (VI) is a process of squeezing a portion of the solvent in the multilayered gel-like molded substance, before stretching the multilayered gel-like molded substance in at least one direction. Process (VI) can be suitably carried out by applying pressure to the face of the multilayered gel-like molded substance by a method of, for example, letting the multilayered gel-like molded substance pass through a space between two, namely, upper and lower, belts or rollers.

The amount of solvent to be squeezed needs to be adjusted, according to the required liquid permeability and filtration object collection efficiency of the substrate for a liquid filter. This adjustment can be made within an appropriate range with the push pressure between the upper and lower belts or rollers, the temperature in the squeezing process, or the frequency of pushes.

The pressure that the multilayered gel-like molded substance receives is preferably adjusted to be from 0.1 MPa to 2.0 MPa in the case of using planar bodies such as belts. In the case of using rollers or the like, the pressure that the multilayered gel-like molded substance receives is preferably adjusted to be from 2 kgf/m to 45 kgf/m.

The squeezing temperature is preferably from 10° C. to 100° C.

Since the frequency of pushes depends of the allowable space in the facility, it is possible to carry out pushing without any particular limitation. If necessary, before the solvent squeezing, single-stage or multi-stage preheating may be conducted to remove a portion of the solvent from the inside of the molded substance (for example, a sheet). In this case, the preheating temperature is preferably from 50° C. to 100° C.

Process (VII) is a process of stretching the multilayered gel-like molded substance, in which the solvent has been squeezed in process (VI) above, in at least one direction to prepare an intermediate molded substance. Here, it is preferable that the stretching in process (VII) is biaxial stretching, and it is possible to suitably use either of a method of serial biaxial stretching, in which longitudinal stretching and transverse stretching are carried out separately, and a method of simultaneous biaxial stretching, in which longitudinal stretching and transverse stretching are carried out simultaneously. Further, a method of stretching plural times in the longitudinal direction and then stretching in the transverse direction, a method of stretching in the longitudinal direction and then stretching plural times in the transverse direction, and a method of performing serial biaxial stretching and then further stretching once or plural times in the longitudinal direction and/or in the transverse direction are also preferable.

The total stretching magnification (=the product of the longitudinal stretching magnification and the transverse stretching magnification) is preferably from 20 times to 60 times, and more preferably from 20 times to 50 times, from the viewpoint of controlling the liquid permeability of the polyolefin microporous membrane and the filtration object collection efficiency. When the stretching magnification is 60 times or less, the frequency of occurrence of breakage may be suppressed low, in the formation of a layered polyolefin microporous membrane. When the stretching magnification is 20 times or more, the occurrence of thickness unevenness may be further suppressed. As described above, it is preferable that stretching is performed in the state in which the solvent remains in a suitable state. The stretching temperature is preferably from 80° C. to 125° C.

After the stretching process of (VII), a heat fixation treatment may be performed. The heat fixation temperature during the heating fixation treatment is preferably from 110° C. to 140° C., from the viewpoint of controlling the liquid permeability of the substrate for a liquid filter and the filtration object collection efficiency. When the heat fixation temperature is 140° C. or lower, the filtration object collection efficiency of the substrate for a liquid filter becomes more excellent. When the heat fixation temperature is 110° C. or higher, the permeation efficiency can be favorably maintained.

Process (VIII) is a process of extracting and washing the solvent from the inside of the intermediate molded substance that has been stretched. Here, in process (VIII), in order to extract the solvent from the inside of the intermediate molded substance (stretched film) that has been stretched, it is preferable to perform washing with a solvent, for example, a halogenated hydrocarbon such as methylene chloride, a hydrocarbon such as hexane, or the like.

In the case of washing by immersing the intermediate molded substance in a tank filled with a solvent, the washing time is preferably from 20 seconds to 150 seconds, in order to obtain a substrate for a liquid filter (a layered polyolefin microporous membrane) having a small elution amount of foreign matters. The washing time is more preferably from 30 seconds to 150 seconds, and particularly preferably from 30 seconds to 120 seconds. Moreover, in order to further enhance the effect of washing, it is preferable that the tank is divided into several stages, the washing solvent is poured from the downstream side of the process of conveying the layered polyolefin microporous membrane, and the washing solvent is made to flow toward the upstream side of the conveying process, such that the purity of the washing solvent in a downstream tank is higher than that of the washing solvent in an upstream tank.

In addition, depending on the required performance for the substrate for a liquid filter, heat set may be performed through an annealing treatment. It is preferable that the annealing treatment is carried out at a temperature of from 50° C. to 150° C., from the viewpoints of conveyance properties in the process and the like. It is more preferable that the annealing treatment is carried out at a temperature of from 50° C. to 140° C.

According to this production method, it is possible to provide a substrate for a liquid filter, which has both excellent liquid permeability and excellent filtration object collection efficiency, and also has a stable liquid permeability in long-term use.

Note that, in this disclosure, the method for producing a substrate for a liquid filter is not limited to the production method described above. For example, in process (III) above, a method may be employed, in which, not by co-extrusion using a flat die or the like, but by providing separately a die for the A layer and a die for the B layer, multilayered gel-like molded substances are extruded from each of the dies, then the two molded substances are bonded together to prepare a layered gel-like sheet. Alternatively, a method of separately preparing a microporous membrane to become an A layer and a microporous membrane to become a B layer, and then preparing a substrate for a liquid filter, in which an A layer and a B layer are bonded, by using an adhesive or the like may be employed.

### EXAMPLES

Hereinafter, an embodiment of the invention is specifically described with reference to Examples; however, the embodiment of the invention is by no means limited to the following Examples unless they are beyond the spirit of the invention. Unless otherwise specifically stated, “parts” is based on mass.

[Measurement Method]

(Water Permeation Efficiency (Water Flow Rate))

A layered polyolefin microporous membrane was immersed in ethanol, and then dried under room temperature. This layered polyolefin microporous membrane was set on a 37-mm diameter liquid permeation cell made of stainless steel (liquid permeation area: S cm²). The layered polyolefin microporous membrane on the liquid permeation cell was wetted with a small amount (0.5 mL) of ethanol. Thereafter, pure water V (100 mL) which had been weighed in advance was passed therethrough at a pressure differential of 90 kPa, and the time T1=(min) needed for the entire amount of pure water to pass was measured. From the volume of pure water and the time needed for the passing of pure water, the water permeation amount Vs per unit time (min)·unit area (cm²) under a pressure differential of 90 kPa was calculated according to the following equation, and this was designated as water permeation efficiency (mL/min·cm²). The measurement was carried out under an atmospheric temperature of 24° C.

Vs=V/(T1×S)

(Bubble Point)

The bubble point of a layered polyolefin microporous membrane was measured in accordance with ASTM E-128-61, using ethanol as the measurement solvent.

(Thickness)

The thickness of a layered polyolefin microporous membrane was measured at 20 spots using a contact type membrane thickness gauge (manufactured by Mitutoyo Corporation), and the obtained values were averaged to determine the thickness. Here, as a contact terminal, a cylindrical terminal having a diameter of a bottom face of 0.5 cm was used. The measurement pressure was set at 0.1 N.

(Porosity)

The porosity (c) of a layered polyolefin microporous membrane was calculated according to the following equation.

£(%)={1−Ws/(ds·t)}×100

Ws: Mass per unit area of the layered polyolefin microporous membrane (g/m²)

ds: True density of polyolefin (g/cm³)

t: Membrane thickness of the layered polyolefin microporous membrane (μm)

Note that, the mass per unit area of the layered polyolefin microporous membrane was determined as follows. A sample was cut into a 10 cm×10 cm piece, and the mass of the piece was measured. The mass was divided by the area, whereby the mass per unit area was determined.

(Solid Collection Efficiency)

100 mL of an aqueous solution containing 0.0045% by mass of gold colloid (average particle diameter of 3 nm) were filtered through a layered polyolefin microporous membrane at a pressure differential of 10 kPa. From the difference between the mass (M1) of the 100-mL aqueous gold colloid solution before filtration and the mass (M2) of the filtrate that had passed through the layered polyolefin microporous membrane, the rate of collection of gold colloid was determined according to the equation described below.

The evaluation of solid collection efficiency was performed as follows: the case in which the rate of collection is 90% or higher was judged as the best (AA), the case in which the rate of collection is 80% or higher but lower than 90% was judged as good (A), and the case in which the rate of collection is lower than 80% was judged as poor (B).

Rate of collection (%)=((M1−M2)/(M1×45×10⁻⁶))×100

(Rate of Change of Permeated Water Amount (Liquid Feeding Stability))

A layered polyolefin microporous membrane was immersed in ethanol, and then dried under room temperature. Five sheets of such layered polyolefin microporous membranes were piled up and set on a 37-mm diameter liquid permeation cell made of stainless steel (liquid permeation area: S cm²) at 0.5-mm intervals. Then, the layered polyolefin microporous membranes on the liquid permeation cell were wetted with a small amount (0.5 mL) of ethanol. Thereafter, 200 mL of pure water were passed through the layered polyolefin microporous membranes under a pressure differential of 40 kPa, and the time (T1) needed for the entire amount of pure water to pass through the layered polyolefin microporous membranes was measured. Immediately after the measurement, the pressure differential state was released. Subsequently, using the same sample, the operation of passing 200 mL of pure water under a pressure differential of 40 kPa and then immediately releasing the pressure difference was repeated 100 times. The time (T100) needed for the 100th passing of 200-mL pure water was measured, and the rate (%) of change of permeated water amount was calculated according to the equation described below.

The evaluation was performed as follows: the case in which the rate of change of permeated water amount is 10% or lower was judged as the best (AA), the case in which the rate of change of permeated water amount is higher than 10% but 15% or lower was judged as good (A), and the case in which the rate of change of permeated water amount exceeds 15% was judged as poor (B). It can be understood that, when the rate of change of permeated water amount is good, a favorable porous structure can be maintained in long-term use.

Rate of change of permeated water amount (%)=(T100−T1)/T1×100

### Example 1

As a solution for the A layer, 20% by mass of an ultra-high molecular weight polyethylene (PE1) having a weight-average molecular weight of 4,400,000 and 80% by mass of a high-density polyethylene (PE2) having a weight-average molecular weight of 300,000 and a density of 0.96 g/cm³ were mixed. Then, 83 parts by mass of liquid paraffin that had been prepared in advance were mixed therewith, such that the total amount of the resin composition became 17 parts by mass, to prepare a polyethylene solution A.

As a solution for the B layer, 5% by mass of an ultra-high molecular weight polyethylene (PE3) having a weight-average molecular weight of 4,400,000, 20% by mass of a high-density polyethylene (PE4) having a weight-average molecular weight of 300,000 and a density of 0.96 g/cm³, and 75% by mass of a filler, which was made of magnesium hydroxide and had an average particle diameter of 0.8 μm, were mixed. Then, 65 parts by mass of liquid paraffin that had been prepared in advance were mixed therewith, such that the total mass of solids became 35 parts by mass, to prepare a polyethylene solution B.

The polyethylene solution A and the polyethylene solution B thus obtained were supplied to a feed block, the solutions were each melt-kneaded at a temperature of 175° C., to obtain melt-kneaded substances. These two melt-kneaded substances were co-extruded from a die and molded into a multilayered sheet-like form. The molded multilayered sheet was cooled to 20° C. in a water bath, to prepare a layered gel-like sheet (base tape). In this process, a water stream was provided on the surface layer of the water bath such that the solvent, which was released from the multilayered sheet that had been gelled in the water bath and which was floating on the surface of the water, did not adhere again to the multilayered sheet.

The base tape thus prepared was conveyed on a roller heated to 40° C. while applying push pressure of 20 kgf/m, thereby removing a portion of liquid paraffin from the inside of the base tape. Thereafter, the base tape was stretched in the longitudinal direction (MD) at a temperature of 90° C. in 4 times magnification, and subsequently stretched in the width direction (TD) at a temperature of 105° C. in 7 times magnification, whereby biaxial stretching was performed. Immediately after stretching, the resulting base tape was subjected to heat treatment (heat fixation) at 128° C.

Next, the base tape that had been subjected to biaxial stretching was immersed in a methylene chloride bath, which was divided into two tanks, successively for 30 seconds per one tank, thereby extracting the liquid paraffin. Here, in a case in which the tank where immersion is initiated is designated as the first tank and the tank where immersion is finished is designated as the second tank, the purity of the washing solvent was set as follows: (lower) the first tank<the second tank (higher).

Thereafter, the methylene chloride was removed by drying at 45° C. and, the resulting base tape was annealed, while being conveyed on a roller heated to 120° C., to obtain a layered polyolefin microporous membrane.

The layered polyolefin microporous membrane thus obtained exhibited excellent collection efficiency such that the rate of collection of gold colloid particles having a particle diameter of 3 nm was 90% or more, and also had excellent liquid feeding stability and excellent liquid permeability.

The production conditions described above are shown in Table 1, and the physical properties of the obtained layered polyolefin microporous membrane are shown in Table 2. Note that, similarly, also regarding the following Examples and Comparative Examples, the production conditions and the physical properties of the obtained layered polyolefin microporous membrane are shown in Table 1 and Table 2.

### Example 2

As a solution for the B layer, 7.5% by mass of an ultra-high molecular weight polyethylene (PE3) having a weight-average molecular weight of 4,400,000, 29.5% by mass of a high-density polyethylene (PE4) having a weight-average molecular weight of 300,000 and a density of 0.96 g/cm³, and 63% by mass of magnesium hydroxide (a filler) were mixed. Then, 65 parts by mass of liquid paraffin that had been prepared in advance were mixed therewith, such that the total mass of solids became 35 parts by mass, to prepare a polyethylene solution B.

A layered polyolefin microporous membrane was obtained in a manner substantially similar to that in Example 1, except that, in Example 1, the polyethylene solution B described above was used.

The layered polyolefin microporous membrane thus obtained exhibited excellent collection efficiency such that the rate of collection of gold colloid particles having a particle diameter of 3 nm was 90% or more, and also had excellent liquid feeding stability and excellent liquid permeability.

### Example 3

As a solution for the B layer, 9% by mass of an ultra-high molecular weight polyethylene (PE3) having a weight-average molecular weight of 4,400,000, 35% by mass of a high-density polyethylene (PE4) having a weight-average molecular weight of 300,000 and a density of 0.96 g/cm³, and 56% by mass of magnesium hydroxide (a filler; average particle diameter of 0.8 μm) were mixed. Then, 70 parts by mass of liquid paraffin that had been prepared in advance were mixed therewith, such that the total mass of solids became 30 parts by mass, to prepare a polyethylene solution B.

A layered polyolefin microporous membrane was obtained in a manner substantially similar to that in Example 1, except that, in Example 1, the polyethylene solution B described above was used.

The layered polyolefin microporous membrane thus obtained exhibited excellent collection efficiency such that the rate of collection of gold colloid particles having a particle diameter of 3 nm was 90% or more, and also had excellent liquid feeding stability and excellent liquid permeability.

### Example 4

As a solution for the B layer, 12% by mass of an ultra-high molecular weight polyethylene (PE3) having a weight-average molecular weight of 4,400,000, 48% by mass of a high-density polyethylene (PE4) having a weight-average molecular weight of 300,000 and a density of 0.96 g/cm³, and 40% by mass of magnesium hydroxide (a filler; average particle diameter of 0.8 μm) were mixed. Then, 74 parts by mass of liquid paraffin that had been prepared in advance were mixed therewith, such that the total mass of solids became 26 parts by mass, to prepare a polyethylene solution B.

A layered polyolefin microporous membrane was obtained in a manner substantially similar to that in Example 1, except that, in Example 1, the polyethylene solution B described above was used.

The layered polyolefin microporous membrane thus obtained exhibited excellent collection efficiency such that the rate of collection of gold colloid particles having a particle diameter of 3 nm was 80% or more, and also had excellent liquid feeding stability and excellent liquid permeability.

### Comparative Example 1

As a solution for the A layer, 20% by mass of an ultra-high molecular weight polyethylene (PE1) having a weight-average molecular weight of 4,400,000 and 80% by mass of a high-density polyethylene (PE2) having a weight-average molecular weight of 300,000 and a density of 0.96 g/cm³ were mixed. Then, 83 parts by mass of liquid paraffin that had been prepared in advance were mixed therewith, such that the total amount of the resin composition became 17 parts by mass, to prepare a polyethylene solution A. As a solution for the B layer, 13% by mass of an ultra-high molecular weight polyethylene (PE3) having a weight-average molecular weight of 4,400,000, 49% by mass of a high-density polyethylene (PE4) having a weight-average molecular weight of 300,000 and a density of 0.96 g/cm³, and 38% by mass of a filler, which was made of magnesium hydroxide and had an average particle diameter of 0.8 μm, were mixed. Then, 76 parts by mass of liquid paraffin that had been prepared in advance were mixed therewith, such that the total mass of solids became 24 parts by mass, to prepare a polyethylene solution B.

A layered polyolefin microporous membrane was obtained in a manner substantially similar to that in Example 1, except that, in Example 1, the above-described polyethylene solution B and polyethylene solution B were used.

The layered polyolefin microporous membrane thus obtained had a low bubble point, and in addition, the rate of collection of gold colloid particles having a particle diameter of 3 nm was less than 80%, and the liquid feeding stability was insufficient.

### Comparative Example 2

As a solution for the A layer, 17% by mass of an ultra-high molecular weight polyethylene (PE1) having a weight-average molecular weight of 4,400,000 and 83 parts by mass of a high-density polyethylene (PE2) having a weight-average molecular weight of 300,000 and a density of 0.96 g/cm³ were mixed. Then, 83 parts by mass of liquid paraffin that had been prepared in advance were mixed therewith, such that the total amount of the resin composition became 17 parts by mass, to prepare a polyethylene solution A.

As a solution for the B layer, 17% by mass of an ultra-high molecular weight polyethylene (PE3) having a weight-average molecular weight of 4,400,000 and 83% by mass of a high-density polyethylene (PE4) having a weight-average molecular weight of 560,000 and a density of 0.96 g/cm³ were mixed. Then, 72 parts by mass of liquid paraffin and 3 parts by mass of decalin that had been prepared in advance were mixed therewith, such that the total mass of solids became 25 parts by mass, to prepare a polyethylene solution B.

The polyethylene solution A and polyethylene solution B thus obtained were supplied to a feed block, the solutions were each melt-kneaded at a temperature of 160° C., to obtain melt-kneaded substances. These two melt-kneaded substances were co-extruded from a die and molded into a multilayered sheet-like form. The molded multilayered sheet was cooled to 25° C. in a water bath, to prepare a layered gel-like sheet (base tape). In this process, a water stream was provided on the surface layer of the water bath such that the solvent, which was released from the multilayered sheet that had been gelled in the water bath and which was floating on the surface of the water, did not adhere again to the multilayered sheet.

The base tape thus prepared was dried at 55° C. for 10 minutes, and then at 95° C. for 10 minutes, thereby removing the decalin from the inside of the base tape. Then, the base tape was conveyed on a roller heated to 85° C. while applying push pressure of 20 kgf/m, thereby removing a portion of liquid paraffin from the inside of the base tape. Thereafter, the base tape was stretched in the longitudinal direction (MD) at a temperature of 100° C. in 5.8 times magnification, and subsequently stretched in the width direction (TD) at a temperature of 100° C. in 14 times magnification, whereby biaxial stretching was performed. Immediately after stretching, the resulting base tape was subjected to heat treatment (heat fixation) at 118° C.

Next, the base tape that had been subjected to biaxial stretching was immersed in a methylene chloride bath, which was divided into two tanks, successively for 30 seconds per one tank, thereby extracting the liquid paraffin. Here, in a case in which the tank where immersion is initiated is designated as the first tank and the tank where immersion is finished is designated as the second tank, the purity of the washing solvent was set as follows: (lower) the first tank<the second tank (higher).

Thereafter, the methylene chloride was removed by drying at 45° C. and, the resulting base tape was annealed, while being conveyed on a roller heated to 110° C., to obtain a layered polyolefin microporous membrane.

The layered polyolefin microporous membrane thus obtained exhibited excellent collection efficiency such that the rate of collection of gold colloid particles having a particle diameter of 3 nm was 80% or more. However, the layered polyolefin microporous membrane had insufficient liquid feeding stability and insufficient water permeation efficiency.

### Comparative Example 3

As a solution for the A layer, 20 parts by mass of an ultra-high molecular weight polyethylene (PE1) having a weight-average molecular weight of 4,400,000 and 80 parts by mass of a high-density polyethylene (PE2) having a weight-average molecular weight of 300,000 and a density of 0.96 g/cm³ were mixed. Then, 83 parts by mass of liquid paraffin that had been prepared in advance were mixed therewith, such that the total amount of the resin composition became 17 parts by mass, to prepare a polyethylene solution A.

As a solution for the B layer, 30% by mass of an ultra-high molecular weight polyethylene (PE3) having a weight-average molecular weight of 4,400,000 and 70% by mass of a high-density polyethylene (PE4) having a weight-average molecular weight of 560,000 and a density of 0.96 g/cm³ were mixed. Then, 53 parts by mass of liquid paraffin and 15 parts by mass of decalin that had been prepared in advance were mixed therewith, such that the total amount of solids became 32 parts by mass, to prepare a polyethylene solution B.

A layered polyolefin microporous membrane was obtained in a manner substantially similar to that in Comparative Example 2, except that, in Comparative Example 2, the above-described polyethylene solution A and polyethylene solution B were used.

The layered polyolefin microporous membrane thus obtained exhibited excellent collection efficiency such that the rate of collection of gold colloid particles having a particle diameter of 3 nm was 80% or more. However, the layered polyolefin microporous membrane had a high bubble point, as well as insufficient liquid feeding stability and insufficient water permeation efficiency.

### Comparative Example 4

As a solution for the A layer, 20% by mass of an ultra-high molecular weight polyethylene (PE1) having a weight-average molecular weight of 4,400,000 and 80% by mass of a high-density polyethylene (PE2) having a weight-average molecular weight of 300,000 and a density of 0.96 g/cm³ were mixed. Then, 83 parts by mass of liquid paraffin that had been prepared in advance were mixed therewith, such that the total amount of the resin composition became 17 parts by mass, to prepare a polyethylene solution A. As a solution for the B layer, 3.9% by mass of an ultra-high molecular weight polyethylene (PE3) having a weight-average molecular weight of 4,400,000, 15.6% by mass of a high-density polyethylene (PE4) having a weight-average molecular weight of 300,000 and a density of 0.96 g/cm³, and 80.5% by mass of magnesium hydroxide (a filler) having an average particle diameter of 0.8 μm were mixed. Then, 66 parts by mass of liquid paraffin that had been prepared in advance were mixed therewith, such that the total mass of solids became 34 parts by mass, to prepare a polyethylene solution B.

A layered polyolefin microporous membrane was obtained in a manner substantially similar to that in Example 1, except that, in Example 1, the above-described polyethylene solution A and polyethylene solution B were used.

The layered polyolefin microporous membrane thus obtained had high water permeation efficiency, and in addition, the rate of collection of gold colloid particles having a particle diameter of 3 nm was less than 80%, and also the liquid feeding stability was insufficient.

TABLE 1

| | | | | | | | Comparative | Comparative | Comparative | Comparative |
|---|---|---|---|---|---|---|---|---|---|---|
| | | | Example 1 | Example 2 | Example 3 | Example 4 | Example 1 | Example 2 | Example 3 | Example 4 |
| Composition | A | Decalin (parts by | — | — | — | — | — | — | — | — |
| of Solution | Layer | mass) | | | | | | | | |
| | | Paraffin (parts by | 83 | 83 | 83 | 83 | 83 | 83 | 83 | 83 |
| | | mass) | | | | | | | | |
| | | PE Concentration | 17 | 17 | 17 | 17 | 17 | 17 | 17 | 17 |
| | | (% by mass) | | | | | | | | |
| | | Total Mass of Resin | 17 | 17 | 17 | 17 | 17 | 17 | 17 | 17 |
| | | Composition | | | | | | | | |
| | | (parts by mass) | | | | | | | | |
| | | PE1 (% by mass) | 20 | 20 | 20 | 20 | 20 | 17 | 20 | 20 |
| | | PE1 Mv | 4,400,000 | 4,400,000 | 4,400,000 | 4,400,000 | 4,400,000 | 4,400,000 | 4,400,000 | 4,400,000 |
| | | PE2 (% by mass) | 80 | 80 | 80 | 80 | 80 | 83 | 80 | 80 |
| | | PE2 Mv | 300,000 | 300,000 | 300,000 | 300,000 | 300,000 | 300,000 | 300,000 | 300,000 |
| | B | Decalin (parts by | — | — | — | — | — | 3 | 15 | — |
| | Layer | mass) | | | | | | | | |
| | | Paraffin (parts by | 65 | 65 | 70 | 74 | 76 | 72 | 53 | 66 |
| | | mass) | | | | | | | | |
| | | PE Concentration | 13 | 17 | 17 | 17 | 17 | 17 | 30 | 12 |
| | | (% by mass) | | | | | | | | |
| | | Total Mass of Solids | 35 | 35 | 30 | 26 | 24 | 25 | 32 | 34 |
| | | (parts by mass) | | | | | | | | |
| | | PE3 (% by mass) | 5 | 7.5 | 9 | 12 | 13 | 17 | 30 | 3.9 |
| | | PE3 Mw | 4,400,000 | 4,400,000 | 4,400,000 | 4,400,000 | 4,400,000 | 4,400,000 | 4,400,000 | 4,400,000 |
| | | PE4 (% by mass) | 20 | 29.5 | 35 | 48 | 49 | 83 | 70 | 15.6 |
| | | PE4 Mv | 300,000 | 300,000 | 300,000 | 300,000 | 300,000 | 560,000 | 560,000 | 300,000 |
| | | Filler Content (% | 75 | 63 | 56 | 40 | 38 | — | — | 80.5 |
| | | by mass) | | | | | | | | |

| | | | | | | | | | |
|---|---|---|---|---|---|---|---|---|---|
| Extrusion | Die Temperature (° C.) | 175 | 175 | 175 | 175 | 175 | 160 | 160 | 175 |
| | Cooling Temperature (° C.) | 20 | 20 | 20 | 20 | 20 | 25 | 25 | 20 |
| Squeezing | First Drying Temperature | — | — | — | — | — | 55 | 55 | — |
| | (° C.) | | | | | | | | |
| | First Drying Time (min) | — | — | — | — | — | 10 | 10 | — |
| | Second Drying | — | — | — | — | — | 95 | 95 | — |
| | Temperature (° C.) | | | | | | | | |
| | Second Drying Time (min) | — | — | — | — | — | 10 | 10 | — |
| | Squeezing Temperature | 40 | 40 | 40 | 40 | 40 | 85 | 85 | 40 |
| | (° C.) | | | | | | | | |
| | Squeezing Pressure (kgf/m) | 20 | 20 | 20 | 20 | 20 | 20 | 20 | 20 |
| Stretching | Longitudinal Stretching | 90 | 90 | 90 | 90 | 90 | 100 | 100 | 90 |
| | Temperature (° C.) | | | | | | | | |
| | Longitudinal Stretching | 4 | 4 | 4 | 4 | 4 | 5.8 | 5.8 | 4 |
| | Magnification (times) | | | | | | | | |
| | Transverse Stretching | 105 | 105 | 105 | 105 | 105 | 100 | 100 | 105 |
| | Temperature (° C.) | | | | | | | | |
| | Transverse Stretching | 7 | 7 | 7 | 7 | 7 | 14 | 14 | 7 |
| | Magnification (times) | | | | | | | | |
| | Heat Fixation | 128 | 128 | 128 | 128 | 128 | 118 | 118 | 128 |
| | Temperature (° C.) | | | | | | | | |
| Extraction | Extraction Time (sec) | 60 | 60 | 60 | 60 | 60 | 60 | 60 | 60 |
| | Drying Temperature (° C.) | 45 | 45 | 45 | 45 | 45 | 45 | 45 | 45 |
| | Annealing Temperature | 120 | 120 | 120 | 120 | 120 | 110 | 110 | 120 |
| | (° C.) | | | | | | | | |

TABLE 2

| | | | | | Comparative | Comparative | Comparative | Comparative |
|---|---|---|---|---|---|---|---|---|
| | Example 1 | Example 2 | Example 3 | Example 4 | Example 1 | Example 2 | Example 3 | Example 4 |
| Thickness (μm) | 23 | 19 | 17 | 16 | 14 | 11 | 10 | 26 |
| Porosity (%) | 74 | 71 | 69 | 61 | 59 | 49 | 51 | 77 |
| Bubble Point (MPa) | 0.64 | 0.63 | 0.63 | 0.40 | 0.30 | 0.60 | 0.83 | 0.31 |
| Water Permeation Efficiency | 3.9 | 2.1 | 2.5 | 1.9 | 1.5 | 0.25 | 0.15 | 4.1 |
| (mL/min · cm²) | | | | | | | | |
| 3-nm Solid Collection | AA | AA | AA | A | B | A | A | B |
| Efficiency | | | | | | | | |
| Liquid Feeding Stability | AA | AA | AA | A | B | B | B | B |

The disclosure of Japanese Patent Application No. 2014-130045 is incorporated by reference herein in its entirety.

All publications, patent applications, and technical standards mentioned in this specification are herein incorporated by reference to the same extent as if such individual publication, patent application, or technical standard was specifically and individually indicated to be incorporated by reference.

1. A substrate for a liquid filter, the substrate comprising at least one A layer which is a microporous membrane-like layer containing a polyolefin, and at least one B layer which is a microporous membrane-like layer containing a polyolefin and a filler, and
the substrate having a bubble point of from 0.40 MPa to 0.80 MPa and a water permeation efficiency of from 1.0 mL/min·cm² to 4.0 mL/min·cm².

2. The substrate for a liquid filter according to claim 1, wherein a content of the filler in the B layer is from 40% by mass to 80% by mass, with respect to a total mass of all solids in the B layer.

3. The substrate for a liquid filter according to claim 1, wherein a porosity of the substrate is 50% or more and less than 75%.

4. The substrate for a liquid filter according to claim 1, wherein a thickness of the substrate is from 7 μm to 25 μm.

5. The substrate for a liquid filter according to claim 1, wherein the polyolefin that is contained in the A layer and the B layer is formed from a polyethylene composition obtained by mixing an ultra-high molecular weight polyethylene having a weight-average molecular weight of 900,000 or more and a high-density polyethylene having a weight-average molecular weight of from 200,000 to 800,000 and a density of from 0.92 g/cm³ to 0.96 g/cm³.

6. The substrate for a liquid filter according to claim 1, wherein an average particle diameter of the filler in the B layer is from 0.2 μm to 2.0 μm.

7. A method for producing the substrate for a liquid filter according to claim 1, the method comprising:
preparing a first solution containing a polyolefin and a solvent;
preparing a second solution containing a polyolefin, a solvent, and a filler;
co-extruding a melt-kneaded substance obtained by melting and kneading the first solution and a melt-kneaded substance obtained by melting and kneading the second solution from a die, and cooling and solidifying to obtain a multilayered gel-like molded substance;
stretching the multilayered gel-like molded substance in at least one direction; and
removing at least a portion of the solvent in the multilayered gel-like molded substance, before or after the stretching in at least one direction.
